(19) United States
(12) Patent Application Publication
(10) Pub. No.: US 2012/0300270 A1
(43) Pub. Date: Nov. 29, 2012

(54) CONTROL CIRCUIT FOR SCANNER LIGHT SOURCE

(76) Inventor: Pan Honglin, Singapore (SG)

(21) Appl. No.: 13/114,275

(22) Filed: May 24, 2011

(51) Int. Cl. H04N 1/04

(52) U.S. Cl. 358/475

(57) ABSTRACT

A light source for a scanning apparatus, the light source includes a light emitting diode; and a control circuit including: a first portion including a first transistor, a second transistor and a resistor for setting a reference current; and a second portion including a third transistor, characteristics of the third transistor being substantially matched to characteristics of the second transistor, wherein an output current provided to light emitting diode by the second portion is substantially equal to the reference current.

### FIELD OF THE INVENTION

The present invention relates to the light source of a scanning apparatus, and more particularly to a control circuit for improved LED brightness control.

### BACKGROUND OF THE INVENTION

Optical scanners operate by imaging an object (e.g. a document) with a light source, and sensing a resultant light signal with an optical sensor array (also called a photosensor array herein). Each optical sensor or photoreceptor in the array generates a data signal representative of the intensity of light impinged thereon for a corresponding portion of the imaged object. The data signals from the array sensors are then processed (typically digitized) and stored in a temporary memory such as a semiconductor memory or on a hard disk of a computer, for example, for subsequent manipulation and printing or display, such as on a computer monitor. The image of the scanned object is projected onto the photosensor array incrementally by use of a moving scan line. The moving scan line is produced either by moving the document with respect to a scan assembly, or by moving the scan assembly relative to the document. Either or both of these methods may be embodied in a flat bed scanner, multi-function printer, or any scanner having manual and automatic feed capabilities.

Various types of photosensor devices can be used in optical scanners. One type of scanner is the contact image sensor (CIS) scanner. A CIS scanner includes a contact image sensor having a length that is substantially equal to the width of the scanning region. The photosensors in a CIS are substantially the same size as the pixel resolution of the scanner. Because the photosensors in the CIS are large, a low power light source (such as one or more LED's) is sufficient to provide enough illumination in the scan line image region. The CIS has a short depth of field and is typically mounted beneath the transparent platen upon which the document is placed. One or more rollers in the CIS carriage are biased against the bottom of the transparent platen so that the CIS is always at substantially the same distance from the top of the transparent platen.

Photosensors in a CCD or CIS scanner photosensor array are aligned in a “cross” direction, i.e., a direction parallel to the longitudinal axis of the scan line image which is projected thereon. The direction perpendicular to the “cross” direction will be referred to herein as the “scan” direction (i.e., the direction of movement of a document or of the photosensor array for scanning of the image).

At any instant when an object is being scanned, each photosensor in the photosensor array has a corresponding area on the object which is being imaged thereon. This corresponding area on the scanned object is referred to herein as a pixel. An area on a scanned object corresponding to the entire extent of the photosensor array is referred to herein as a scan line. For descriptive purposes, a scanned object is considered to have a series of fixed adjacently positioned scan lines. Further, scanners are typically operated at a scan line sweep rate such that one scan line width is traversed during each sampling interval.

In order to provide high quality scanned images, it is important for the brightness of the light emitting diodes in the light source to be well controlled. LED brightness can be adjusted using pulse width modulation. For consistent image scanning quality from scanner to scanner, it is important to control a nominal level of LED brightness for the red, green and blue LED's. For scanner light sources including a plurality of red LED's, a plurality of green LED's and a plurality of blue LED's to provide substantially uniform illumination across the scanning region, it is also important to control the nominal brightness of each of the LED's.

FIG. 1 shows a typical prior art control circuit for an LED in a scanner light source. LED 10 is in series with power supply Vₛ, transistor 15 and resistor R₁₂. Input voltage Vᵢₙ at the transistor base is typically pulse width modulated for some amount of adjustment. When transistor 15 is on and when LED 10 is conducting, there is a forward voltage V_{f} across LED 10 and there is a collector-emitter voltage V_{CE} across transistor 15. The current I through LED 10 is given by:

I=(Vₛ−V_{CE}−V_{f})/R₁₂ 1)

The part-to-part variation in forward voltage V_{f} for commercially available red LED's and green LED's is typically sufficiently small that the control circuit shown in FIG. 1 is adequate. However, the part-to-part variation in forward voltage for commercially available blue LED's is typically larger and can result in a variation in LED current I according to equation 1), resulting in a variation in brightness. A brute force solution is to test many LED's and select appropriate current limiting resistors R₁₂ by trial and error. This takes time and adds expense.

What is needed is a control circuit to provide a well-controlled LED current and brightness that is independent of the LED forward voltage V_{f} so that it is not necessary to compensate for varying forward voltage from part to part.

### SUMMARY OF THE INVENTION

The present invention is directed to overcoming one or more of the problems set forth above. Briefly summarized, according to one aspect of the invention, the invention resides in a light source for a scanning apparatus, the light source comprising: a light emitting diode; and a control circuit including: a first portion including a first transistor, a second transistor and a resistor for setting a reference current; and a second portion including a third transistor, characteristics of the third transistor being substantially matched to characteristics of the second transistor, wherein an output current provided to light emitting diode by the second portion is substantially equal to the reference current.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a circuit diagram for a prior art control circuit for an LED in a scanner light source;

FIG. 2 is a perspective view of a multifunction printer of the present invention having an automatic document feeder in the closed position;

FIG. 3 is a perspective view of the multifunction printer of FIG. 2 with the ADF in the open position;

FIG. 4 is a circuit diagram for a control circuit for the light source of a scanning apparatus according to an embodiment of the invention;

FIG. 5 is a circuit diagram for a control circuit for a plurality of light sources of a scanning apparatus according to an embodiment of the invention; and

FIG. 6 is a schematic diagram showing how the different parts of the scanning apparatus are related to one another and to an external computer.

### DETAILED DESCRIPTION OF THE INVENTION

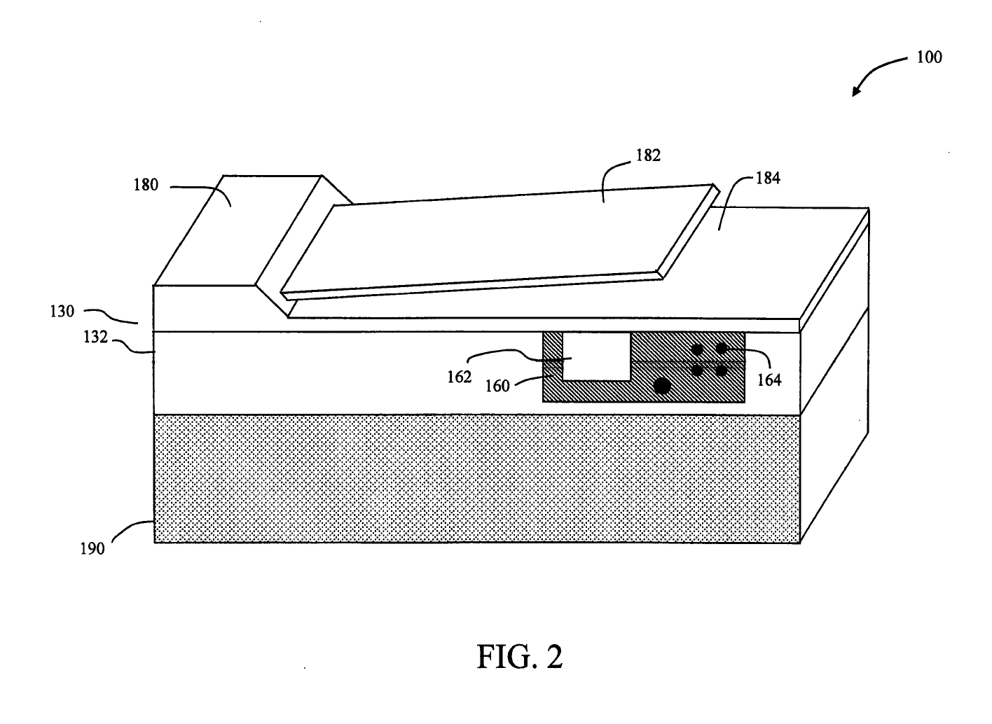

FIG. 2 shows a perspective view of a multifunction printer 100 including a scanning apparatus 130, an optional automatic document feeder (ADF) 180, and a printing apparatus 190, such as an inkjet printer. Multifunction printer 100 can do printing, scanning of documents, or copying of documents (i.e. printing plus scanning). ADF 180 includes an input tray 182 where documents for scanning or copying are stacked, output tray 184 for receiving scanned documents. A control panel 160 for allowing the user to interface with the multifunction printer 100 includes a display 162 and control buttons 164.

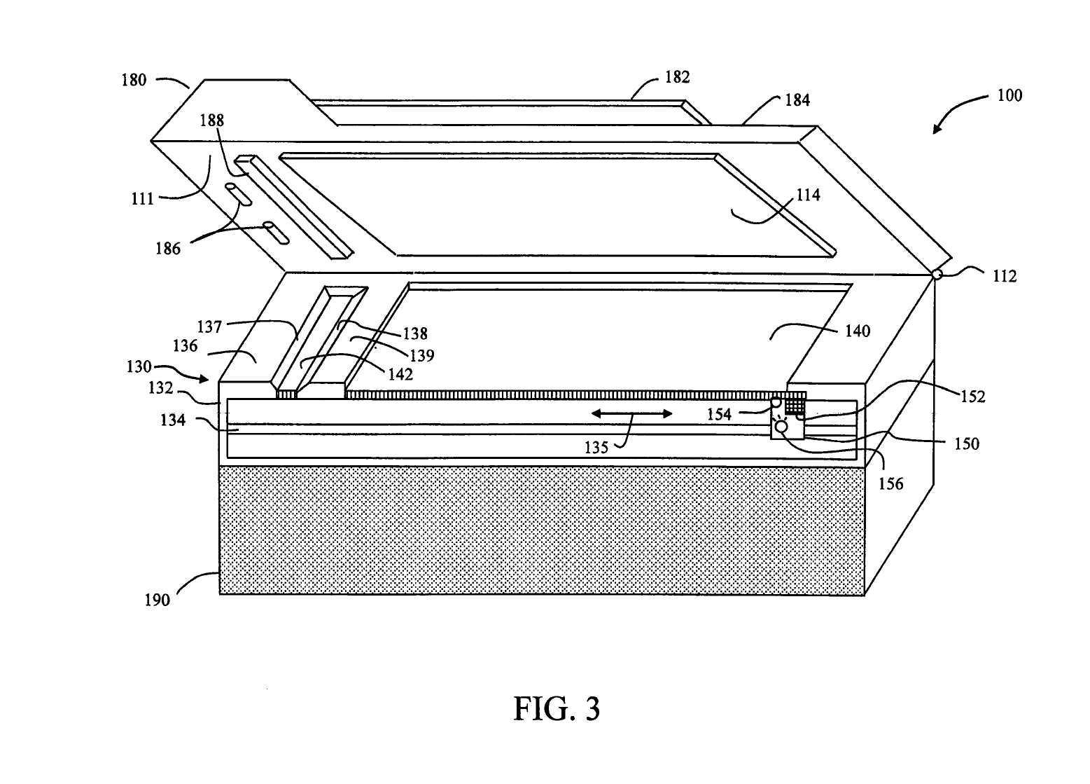

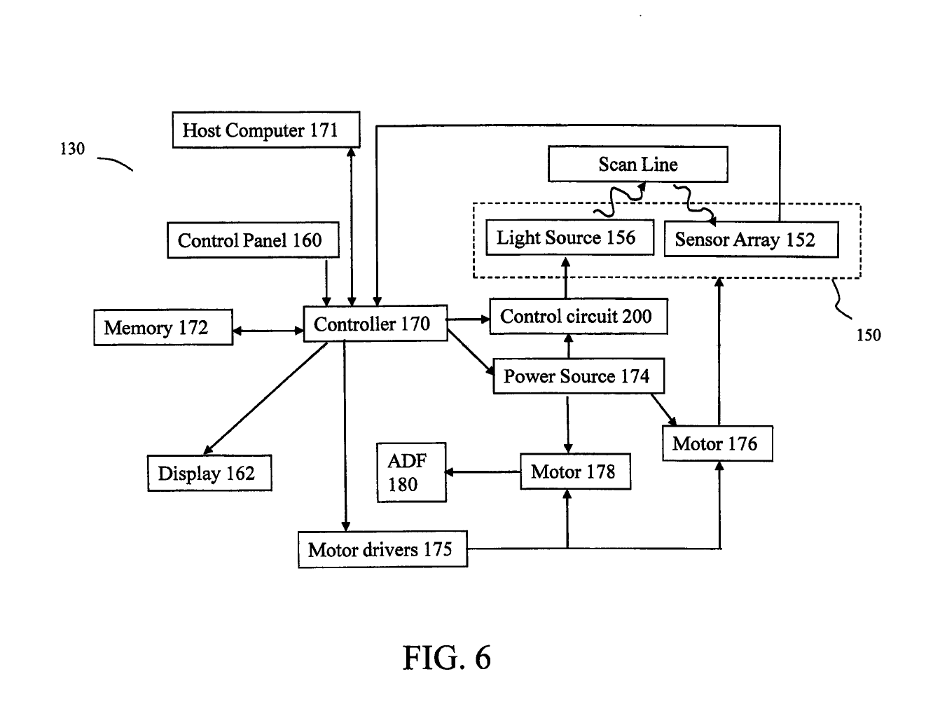

As shown in FIG. 3 (similar to FIG. 2 but in a cut-away view and with the ADF 180 raised up), ADF 180 can be attached to scanning apparatus body 132 of scanning apparatus 130 by a hinge 112, so that the under side 111 of ADF 180 can function as a lid for scanning apparatus 130. The surface of scanning apparatus body 132 that is covered by under side 111 of ADF 180 when ADF 180 is closed includes a frame 136. Transparent platen 140 (typically a flat piece of glass) is inset within the frame 136. The front of scanning apparatus 130 is cut away in FIG. 3 in order to show movable scan assembly 150 below transparent platen 140. Scan assembly 150 includes a photosensor array 152 (such as a contact image sensor) extending the width of the transparent platen 140, and a light source 156 that illuminates a scan line of a document or other item (not shown) that is placed on top of transparent platen 140. For a color CIS scanner, light source 156 typically includes a plurality of red, green and blue LED's. A light guide and other optics (not shown) can also be included in scan assembly 150. Scan assembly 150 is moved back and forth along scanning guide 134 in scanning direction 135 across the length of transparent platen 140 with bearing surface 154 (e.g. a roller) in contact with the underside of transparent platen 140 in order to scan the document or other item. Photosensor array 152 receives reflected light from the item through the transparent platen 140 scan line by scan line and converts the reflected light into electrical signals. A controller 170 (FIG. 6) converts the electrical signals into digitized data to form a digitized image of the item. Scanning guide 134 can be a round rail, a rack and pinion or other guiding member that can use the power of a motor (not shown) to provide a linear motion along the scanning direction 135.

In the manual scanning region a pressing plate 114 is affixed to under side 111. Pressing plate 114 can be compressible and/or it can be resiliently mounted on under side 111 so that when ADF 180 is lowered over an item to be manually scanned, the item is pressed against transparent platen 140. Pressing plate 114 typically has a white surface to serve as an optical background and reference for scanning as scan assembly 150 is moved to scan the item. A separate ADF transparent platen 142 (separated from platen 140 by spacer 139) is provided for scanning documents being fed by ADF 180. The document to be scanned is moved by a transporter such as rollers 186 down the down ramp 137, across the ADF transparent platen 142, up the up ramp 138 and toward the under side 111 through which it passes on its way to output tray 184. A pressing member 188 forces the document into contact with ADF transparent platen 142 for scanning by scan assembly 150, which is parked below ADF transparent platen 142 during ADF scanning.

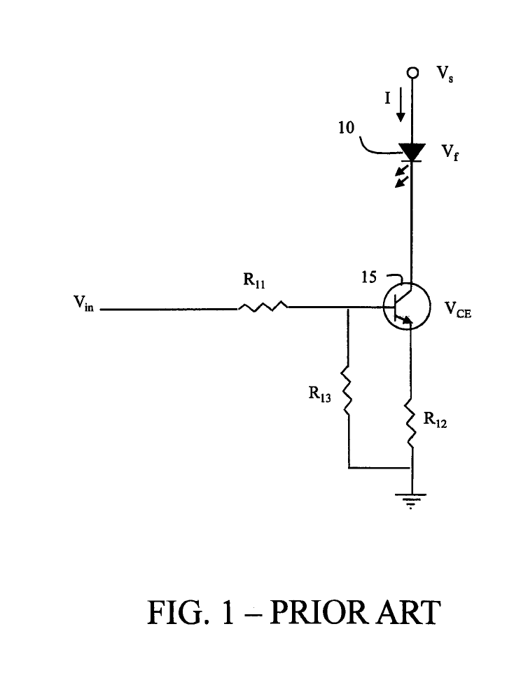

In order to provide high quality scanned images, it is important for the brightness of the light emitting diodes in the light source 156 to be well controlled. LED brightness can be adjusted using pulse width modulation. For consistent image scanning quality from scanner to scanner, it is important to control a nominal level of LED brightness for the red, green and blue LED's. For scanner light sources including a plurality of red LED's, a plurality of green LED's and a plurality of blue LED's to provide substantially uniform illumination across the scanning region, it is also important to control the nominal brightness of each of the LED's. As discussed in the background above, for the prior art control circuit shown in FIG. 1, if the forward voltage V_{f} of the LED varies significantly from part to part, the LED current and brightness will also vary from part to part, unless compensated for by resistor R₁₂ (equation 1).

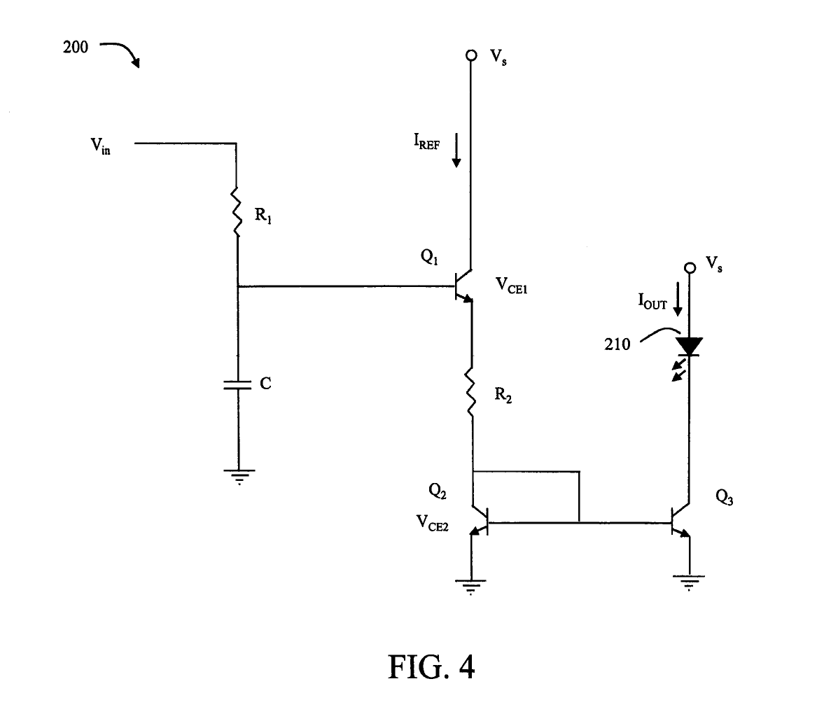

In embodiments of the present invention, a control circuit 200, such as the one shown in FIG. 4, is used to cause the LED current to be substantially independent of LED forward voltage, so that compensation for part-to-part variation is not required. Independence of diode current from the forward voltage of the LED is provided by a current mirror section of the circuit that includes matched transistors Q₂ and Q₃. In the particular example shown in FIG. 4, Q₂ and Q₃ are NPN bipolar transistors with their emitters connected to ground. In addition, the collector of Q₂ is connected to the base of Q₂, and the bases of Q₂ and Q₃ are connected together. As is known to one skilled in the art, if the transistor characteristics of Q₂ and Q₃ are well matched, the output collector current I_{OUT} for Q₃ (i.e. the current through LED 210 that is connected to the collector of Q₃) is substantially equal to the reference collector current I_{REF} for Q₂. While not being bound by theory, an approximation for the operation of a current mirror is as follows. Because the collector and base of Q₂ are connected together (V_{CB}=0), the voltage drop across Q₂ is V_{CE2}=V_{BE2}. Because the collector of Q₂ is also connected to the base of Q₃, this also sets the base to emitter voltage of Q₃ to V_{BE3}=V_{BE2}. If the device characteristics of Q₂ and Q₃ are well-matched (i.e. if their values of β for the ratio of collector current to base current are substantially equal), then I_{OUT}=(βI_{B}, where I_{B} is the base current for Q₃ which is equal to the base current for Q₂. By Kirchoff's current law,

I_{REF}=I_{OUT}+2I_{B}=I_{OUT}(1+2/β)˜I_{OUT} 2),

since β is typically on the order of 100. As indicated by equation 2), I_{OUT}, which passes through LED 210 is substantially equal to reference current I_{REF} and is independent of the forward voltage of LED 210. In some cases Q₂ and Q₃ can be suitably matched by selecting them from the same manufacturing batch of the same part number of transistors. An even better match of transistor characteristics can be obtained if Q₂ and Q₃ are integrated together side by side on the same silicon die, so that manufacturing variations are very small. Another advantage of integrating Q₂ and Q₃ on the same piece of silicon, is that the operating temperature of both transistors will remain substantially equal, which further ensures that their device characteristics remain substantially equal.

In addition to the current mirror section described above, control circuit 200 also includes an input section that determines I_{REF}. Considering the portion of the circuit that includes transistors Q₁ and Q₂, resistor R₂ and supply voltage Vₛ, if transistor Q₁ is turned on, then

I_{REF}=(Vₛ−V_{CE1}−V_{CE2})/R₂=(Vₛ−V_{CE1}−V_{BE})/R₂ 3),

where the collector to emitter voltage across transistor Q₂ is equal to the base to emitter voltage of a forward biased transistor (since the collector is connected to the base), which is approximately equal to 0.7V. If the DC supply voltage is 5.0 volts, then current through LED 210 is I_{OUT}˜I_{REF}˜(4.3V−V_{CE1})/R₂. Brightness of LED 210 is further adjusted by pulse width modulation. In particular the voltage applied to the base of Q₁ is controlled by an input voltage signal Vᵢₙ that is pulse width modulated to turn Q₁ on with a duty cycle related to the pulse width and pulse frequency. When Q₁ is on, current I_{OUT}˜I_{REF} flows through LED 210 and turns it on. When Q₁ is off, I_{REF} is 0 so no current flows through LED 210. The on/off pulsing is sufficiently rapid that a substantially uniform light output is provided without noticeable flicker. The higher the duty cycle, the brighter LED 210 appears.

Control circuit 200 can be described as including a first portion including a first transistor Q₁, a second transistor Q₂ and a resistor R₂ for setting a reference current I_{REF}; and a second portion including a third transistor Q₃, such that characteristics of transistor Q₃ are substantially matched to characteristics of transistor Q₂ so that an output current I_{OUT} provided to LED 210 is substantially equal to reference current I_{REF}. For embodiments as in FIG. 4, Q₃ and Q₃ are bipolar transistors, and the collector and the base of Q₂ are connected together. In addition, the base of Q₃ is connected to the base of Q₂, and the emitters of Q₂ and Q₃ are grounded.

Alternatively, Q₂ and Q₃ can be matched field effect transistors instead of matched bipolar transistors. In such embodiments, the drain and the gate of Q₂ are connected together. In addition, the gate of Q₃ is connected to the gate of Q₂, and the sources of Q₂ and Q₃ are grounded.

Because the forward voltage of a blue LED varies significantly from part to part, the embodiments of control circuit 200 are particularly advantageous when the LED is a blue LED. However, embodiments of control circuit can also be used for red LED's or green LED's in addition to the blue LED's. In particular, a first control circuit 200 would be used with a blue LED with a particular value of R₂ to set the current through the blue LED to set the nominal level of brightness. A second control circuit 200 would be used with a red or green LED with a particular value of R₂′ instead of R₂ to determine the current through the red or green LED in order to set the nominal level of brightness. R₂′ would typically be selected to be different from R₂, so that the output current through the red or green LED would be appropriate for the required nominal brightness of those devices, but different from the output current through the blue LED.

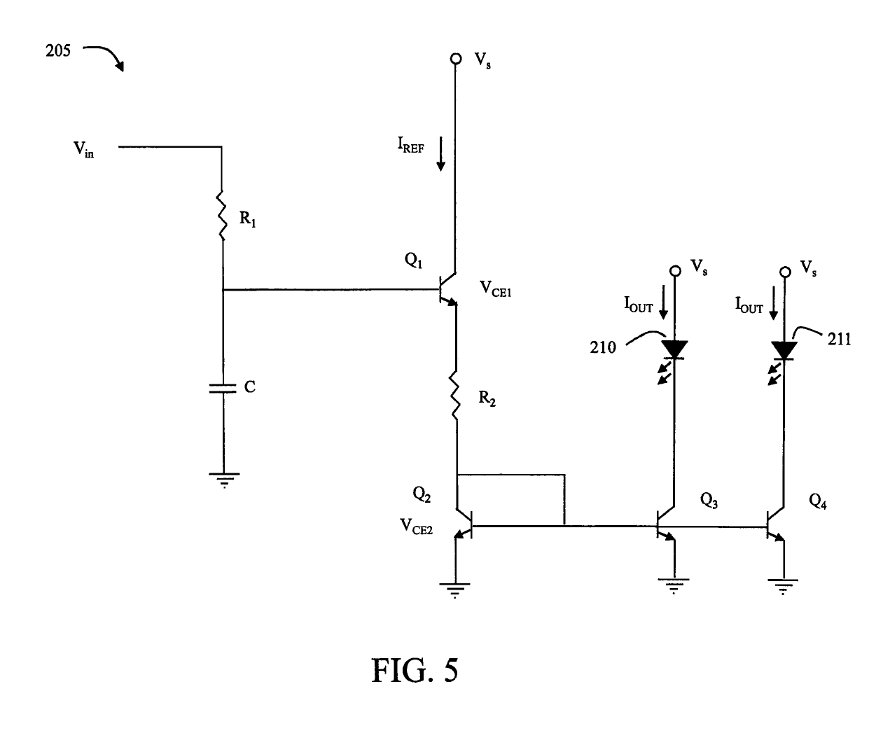

For light sources 156 (FIG. 3) including a plurality of LED's of the same color (for example, a plurality of blue LED's), the current mirror portion of the circuit can be extended to provide output currents substantially equal to the reference current for the plurality of LED's of the same color. FIG. 5 shows control circuit 205 for providing output currents I_{OUT} through each of two LED's 210 and 211, where I_{OUT} is substantially equal to I_{REF} for both LED's 210 and 211. This can be achieved by providing a fourth transistor Q₄ whose characteristics are substantially matched with those of the second transistor Q₂ and the third transistor Q₃. For a bipolar transistor embodiment as in FIG. 5, the base of Q₄ is connected to the bases of Q₂ and Q₃, the emitter of Q₄ is grounded, and LED 211 is connected to the collector of Q₄. Matching of transistors Q₂, Q₃ and Q₄ can be achieved by selecting transistors from the same batch, or by integrating them all on the same die.

Whether scanning apparatus 130 is a stand-alone unit or is incorporated into a multifunction printer or copier, scanning apparatus 130 will have a controller 170 including hardware and software or firmware. FIG. 6 schematically shows controller 170 and its relationship with other portions of scanning apparatus 130, printing apparatus 190 and associated computer. In normal scanning operation in the active mode of operation, a user can initiate a scanning operation from control panel 160, or alternatively a scanning job can be initiated from host computer 171 to which the scanning apparatus 130 or multifunction printer 100 is connected. In either case a signal is sent to controller 170, which then sends a signal to power source 174 to turn on light source 156 and also to a motor driver 175 to operate motor 176 (in the case of manual scanning) in order to move sensor array module 150 along scanning direction 135. As sensor array module 150 is moved, light from light source 156 reflects off a document or other object that is placed on transparent platen 140, and impinges on photosensor array 152 one scan line at a time. A scan line electrical signal is sent from photosensor array 152 to controller 170 where the signals can be further processed before sending digitized data to memory 172 (or to host computer 171) in order to compose an entire digitized scanned image, scan line by scan line. When the scan is completed, controller 170 sends a signal to motor driver 175 to send power to motor 176 in order to return scan assembly 150 to its home position. Scanning with an ADF 180 is similar, except the controller sends a signal to a motor driver 175 to send power from power source 174 to operate motor 178 to power the ADF document transporter to move the documents over the transparent platen 142 as described above.

The invention has been described in detail with particular reference to certain preferred embodiments thereof, but it will be understood that variations and modifications can be effected within the spirit and scope of the invention.

### PARTS LIST

100 Multifunction printer
111 Under side of automatic document feeder
112 Hinge
114 Pressing plate
130 Scanning apparatus
132 Scanning apparatus body
134 Scanning guide
135 Scanning direction
136 Frame
137 Down ramp
138 Up ramp
139 Spacer
140 Transparent platen
142 ADF transparent platen
150 Scan assembly
152 Photosensor array
154 Bearing surface (of scan assembly)
156 Light source
160 Control panel
162 Display
164 Control buttons
170 Controller
171 Host computer
172 Memory
174 Power source
175 Motor drivers
176 Motor (for sensor array)
178 Motor (for automatic document feeder)
180 Automatic document feeder
182 Input tray
184 Output tray
186 Document feed rollers
188 Pressing member
190 Printing apparatus
200 Control circuit
205 Control circuit
210 LED
211 LED

1. A light source for a scanning apparatus, the light source comprising:
a light emitting diode; and
a control circuit including:
a first portion including a first transistor, a second transistor and a resistor for setting a reference current; and
a second portion including a third transistor, characteristics of the third transistor being substantially matched to characteristics of the second transistor, wherein an output current provided to light emitting diode by the second portion is substantially equal to the reference current.

2. The light source of claim 1, wherein the light emitting diode is a blue light emitting diode.

3. The light source of claim 1, the second transistor and the third transistor being bipolar transistors, wherein the collector of the second transistor is connected to the base of the second transistor.

4. The light source of claim 3, wherein the base of the third transistor is connected to the base of the second transistor.

5. The light source of claim 3, wherein the emitter of the second transistor and the emitter of the third transistor are grounded.

6. The light source of claim 1, the second transistor and the third transistor being field effect transistors, wherein the drain of the second transistor is connected to gate of the second transistor.

7. The light source of claim 6, wherein the gate of the third transistor is connected to the gate of the second transistor.

8. The light source of claim 6, wherein the source of the second transistor and the source of the third transistor are grounded.

9. The light source of claim 1, the light emitting diode being a first light emitting diode, further comprising at least one additional light emitting diode of the same type as the first light emitting diode, wherein the at least one additional light emitting diode is connected to a fourth transistor, wherein characteristics of the fourth transistor are substantially matched to characteristics of the second transistor.

10. The light source of claim 1 further comprising a pulse width modulation input connected to the first transistor.

11. The light source of claim 1, the light emitting diode being a first light emitting diode and the control circuit being a first control circuit having a first output current, further comprising:
a second light emitting diode of a different type from the first light emitting diode; and
a second control circuit for providing a second output current to the second light emitting diode.

12. The light source of claim 11, wherein the second output current is different from the first output current.

13. A scanning apparatus comprising:
a photosensor array;
a transparent platen; and
a light source comprising:
a light emitting diode; and
a control circuit including:
a first portion including a first transistor, a second transistor and a resistor for setting a reference current; and
a second portion including a third transistor, characteristics of the third transistor being substantially matched to characteristics of the second transistor, wherein an output current provided to light emitting diode by the second portion is substantially equal to the reference current.

14. The scanning apparatus of claim 13, wherein the light emitting diode is a blue light emitting diode.

15. The scanning apparatus of claim 13, the second transistor and the third transistor being bipolar transistors, wherein the collector of the second transistor is connected to the base of the second transistor.

16. The scanning apparatus of claim 15, wherein the base of the third transistor is connected to the base of the second transistor.

17. The scanning apparatus of claim 15, wherein the emitter of the second transistor and the emitter of the third transistor are grounded.

18. The scanning apparatus of claim 13, the second transistor and the third transistor being field effect transistors, wherein the drain of the second transistor is connected to gate of the second transistor.

19. The scanning apparatus of claim 18, wherein the gate of the third transistor is connected to the gate of the second transistor.

20. The scanning apparatus of claim 18, wherein the source of the second transistor and the source of the third transistor are grounded.

21. The scanning apparatus of claim 13, the light emitting diode being a first light emitting diode, further comprising at least one additional light emitting diode of the same type as the first light emitting diode, wherein the at least one additional light emitting diode is connected to a fourth transistor, wherein characteristics of the fourth transistor are substantially matched to characteristics of the second transistor.

22. The scanning apparatus of claim 13 further comprising a pulse width modulation input connected to the first transistor.

23. The scanning apparatus of claim 13, the light emitting diode being a first light emitting diode and the control circuit being a first control circuit having a first output current, further comprising:
a second light emitting diode of a different type from the first light emitting diode; and
a second control circuit for providing a second output current to the second light emitting diode.

24. The scanning apparatus of claim 23, wherein the second output current is different from the first output current.
